(19) United States
(12) Patent Application Publication
(10) Pub. No.: US 2023/0210721 A1
(43) Pub. Date: Jul. 6, 2023

(54) LOCKABLE VIAL SLEEVE AND RELATED SYSTEMS AND METHODS

(71) Applicant: Fisher BioServices Inc., Rockville, MD (US)

(72) Inventor: Abdul H. Ally, Gaithersburg, MD (US)

(21) Appl. No.: 18/147,271

(22) Filed: Dec. 28, 2022

Related U.S. Application Data
(60) Provisional application No. 63/392,940, filed on Jul. 28, 2022.
(60) Provisional application No. 63/295,468, filed on Dec. 30, 2021.

(51) Int. Cl. A61J 1/14

(52) U.S. Cl. CPC A61J 1/1425

(57) ABSTRACT

A lockable vial sleeve assembly includes a sleeve configured to house a vial, the sleeve defining a body and a first opening provided at one end of the body, the first opening configured to receive the vial therethrough. A locking member is configured to pivotably lock to the sleeve adjacent the one end. The vial is insertable into the body through the first opening, and in response to the locking member being pivotably locked to the sleeve, the locking member at least partially closes the first opening to restrict withdrawal of the vial through the first opening.

### CROSS-REFERENCE TO RELATED APPLICATIONS

This application claims priority to U.S. Provisional Patent Application No. 63/295,468, filed on Dec. 30, 2021, and entitled LOCKABLE VIAL SLEEVE AND RELATED SYSTEMS AND METHODS, and U.S. Provisional Patent Application No. 63/392,940, filed on Jul. 28, 2022, and entitled LOCKABLE VIAL SLEEVE AND RELATED SYSTEMS AND METHODS, the contents of each of which is herein incorporated by reference in its entirety.

### FIELD OF THE INVENTION

This invention relates generally to lockable vial sleeves and, more particularly, to devices, systems, and methods for irreversibly locking a vial in a vial sleeve.

### BACKGROUND OF THE INVENTION

Various biological products, samples, or aliquots such as those containing living human cells including, for example, allogeneic and autologous biopharmaceutical products, must often be maintained at cryogenic temperatures (e.g., between −195° C. and −150° C.) or “cryopreserved” in order to maintain their integrity. Cryogenic containers or vials, such as those sold commercially by Aseptic Technologies, Daikyo Crystal Zenith, or Nunc, for example, are typically used to store and/or transport such products in a cryogenic environment(s). Such vials may be available in a variety of sizes, such as having 1 mL, 2 mL, 6 mL, 10 mL, 20 mL, and 50 mL capacities, for example. While cryogenic vials may be provided in various sizes and configurations, a typical vial includes a hollow cylindrical body constructed of a transparent material capable of withstanding cryogenic temperatures.

In many cases, it may be beneficial to store cryogenic or other vials within a lockable sleeve. A visual inspection by a user, such as a technician, of the contents of the vial through the transparent cylindrical body may be insufficient to allow the user to identify the particular product or type of product contained in the vial. Thus, a label containing indicia indicating the particular product or type of product contained in the vial, as well as other necessary indicia, is often adhered to the exterior surface of the side wall of the cylindrical body.

However, despite a label being adhered to the side wall of the cylindrical body, in some examples, it is undesirable to have the label be readily visible by a user, such as a technician, of the vial. For example, in some cases, the vial may be placed in a lockable sleeve and rotated within the sleeve to hide a label placed on the vial. It may be beneficial to hide a label of the contents of the vial if such a label is intended to be hidden from a technician performing, for example, a blind study.

With the emerging development of such autologous and allogeneic cell therapy treatments, there is a need to identify basic features for cells that are manufactured and aliquoted into cryogenic containers (such as those described above) by applying a label to each container. Once the aliquoting process is completed, the cells must be stabilized by a controlled-rate freezing process which is cryogenically stored in order to actively preserve the cells for future patient treatment. There is a need to perform an additional labeling step just prior (just in time labeling) to shipping cryogenically stored vial/s of cells for infusion into patients enrolled in clinical trials or commercial treatment. This additional label can include details such as clinical treatment identification (ID), cohort ID, clinical center information and other salient features relating to the treatment regimen.

Further, for blinded clinical trials where the drug details (cell details in this case) need to be obscured before and during treatment, the primary label needs to be hidden from the treatment center and patient, and a label may be applied that is patient or cohort-specific (but does not contain unblinding information) to a cryogenically frozen vial just prior to shipment.

Therefore, it would be desirable to provide improved labeling devices, systems, and methods for containing a cryogenic vial or other vial which address these and other problems associated with conventional label exposure.

### SUMMARY OF THE INVENTION

In one embodiment, a lockable vial labeling sleeve assembly is provided. The lockable vial sleeve assembly includes a vial sleeve configured to house a vial and a locking member configured to rotatably lock with the vial sleeve after the vial has been at least partially inserted into the vial sleeve.

The vial sleeve includes a body and a first opening provided on one end of the body configured to at least partially receive the vial therethrough. The locking member is configured to rotatably lock with the body adjacent the one end. The locking member at least partially closes the first opening after the vial is received at least partially through the first opening and the locking member is rotatably locked with the body adjacent the one end.

In one embodiment, the body of the vial includes a first locking feature defined by a recess entrance, a recess channel, and a recess lock formed in an inner surface of the body. The locking member includes a locking member body having a circumferential side wall and a second locking feature defined by at least one locking lug extending radially outwardly from the circumferential side wall. The second locking feature is configured to cooperate with the first locking feature to rotatably lock the locking member with the body adjacent the one end.

In another embodiment, the body of the vial sleeve is provided with a rectangular or square base extending outwardly from the body of the vial sleeve. The base defines a rectangular or square first opening at the one end of the vial sleeve that is configured to at least partially receive a vial therethrough. The first opening includes an opposite pair of elongated locking channels provided on opposite sides of the first opening.

A locking member is provided in the form of a locking plate having an opposite pair of locking tabs provided on opposite sides of the locking member. The pair of opposite locking tabs are configured to engage and lock with the opposite pair of locking channels provided on the opposite sides of the first opening when the locking member is rotatably locked with the vial sleeve. The locking member at least partially closes the first opening after the vial is received at least partially through the first opening and the locking member is rotatably locked with the body adjacent the one end.

In another embodiment, a method of locking a vial in a vial sleeve of a lockable vial sleeve assembly is provided. The method includes receiving the vial into an interior space defined by the vial sleeve. The vial sleeve includes a body and a first opening provided on one end of the body being configured to at least partially receive a vial therethrough. The method further includes inserting a locking member into the first opening, with the locking member being configured to rotatably lock with the body adjacent the one end. Furthermore, the locking member at least partially closes the first opening after the vial is received at least partially through the first opening. The method further includes rotating the locking member relative to the body to lock the vial within the vial sleeve.

In yet another embodiment, a kit is provided. The kit includes a vial sleeve configured to house a vial. The vial sleeve includes a body and a first opening provided at one end of the body. The first opening is configured to at least partially receive a vial therethrough. The kit further includes a locking member being configured to rotatably lock with the body adjacent the one end, with the locking member being configured to at least partially close the first opening after the vial is received at least partially through the first opening and the locking member is rotatably locked with the body adjacent the one end. The kit further includes a locking tool that is configured to removably engage the locking member to rotate the locking member relative to the body of the vial sleeve to rotatably lock the locking member with the body.

In yet another example of an embodiment, a lockable vial sleeve assembly includes a sleeve configured to house a vial, the sleeve defining a body and a first opening provided at one end of the body, the first opening configured to receive the vial therethrough. A locking member is configured to pivotably lock to the sleeve adjacent the one end. The vial is insertable into the body through the first opening, and in response to the locking member being pivotably locked to the sleeve, the locking member at least partially closes the first opening to restrict withdrawal of the vial through the first opening.

In another example of an embodiment, the locking member includes a first locking tab and a second locking tab, the second locking tab is configured to engage the sleeve while the first locking tab is in engagement with the sleeve.

In another example of an embodiment, the sleeve defines a first locking channel spaced from a second locking channel, and the locking member includes a first locking tab and a second locking tab, the second locking tab is configured to be inserted into the second locking channel while the first locking tab is received by the first locking channel.

In another example of an embodiment, the first locking channel is positioned on an opposite side of the sleeve as the second locking channel.

### BRIEF DESCRIPTION OF THE DRAWINGS

The accompanying drawings, which are incorporated in and constitute a part of this specification, illustrate an embodiment of the invention and, together with a general description of the invention given above, and the detailed description given below, serve to explain the invention.

FIG. 1 is a perspective view of an exemplary lockable vial sleeve assembly including a vial sleeve housing a vial, and the vial including a sample therein.

FIG. 2 is a perspective view of the vial sleeve assembly of FIG. 1, and shows additional components of the lockable vial sleeve assembly, including a locking member.

FIG. 3 is a disassembled perspective view of the vial sleeve assembly of FIG. 2 also showing a locking tool.

FIG. 4 is a partial bottom perspective view of the vial sleeve shown in FIG. 2.

FIG. 5 is a bottom perspective view of the locking member shown in FIG. 2.

FIG. 5A is a perspective view of an alternative embodiment of the locking member shown in FIG. 5 comprising a circular locking disc.

FIG. 6 is a bottom plan view of the locking member shown in FIG. 5.

FIG. 6A is an enlarged view of the encircled area of FIG. 6.

FIG. 7 is a cross-sectional view of the disassembled lockable vial sleeve assembly of FIG. 2, with a locking tool inserted into the locking member.

FIG. 8 is a cross-sectional view of the assembled lockable vial sleeve assembly and the locking member of FIG. 7, with the locking tool inserted into the locking member.

FIG. 9A is a bottom plan view of the lockable vial sleeve assembly as shown in FIG. 8, taken along line 9A-9A of FIG. 8.

FIG. 9B is a view similar to FIG. 9A showing rotation of the locking tool and locking member to rotatably lock the locking member with the vial sleeve.

FIG. 10A is a cross-sectional view, taken along line 10A-10A of FIG. 8.

FIG. 10B is a view similar to FIG. 10A showing rotation of the locking member to rotatably lock the locking member with the vial sleeve.

FIG. 11 is an enlarged view of the encircled area 11 of FIG. 10B.

FIG. 12 is a partial bottom perspective view of a vial sleeve in accordance with an alternative embodiment of the vial sleeve shown in FIG. 1.

FIG. 13 is a bottom perspective view of a locking member in accordance with an alternative embodiment of the locking members shown in FIGS. 5 and 5A.

FIG. 14 is a top perspective view of a locking tool configured to engage and rotate the locking member shown in FIG. 13.

FIG. 15 is a bottom plan view of the locking member shown in FIG. 13.

FIG. 16 is a bottom plan view of the vial sleeve shown in FIG. 12.

FIG. 17A is a bottom plan view of the vial sleeve shown in FIG. 12 and the locking member shown in FIG. 13, showing rotation of the locking member to rotatably lock the locking member with the vial sleeve,

FIG. 17B is a view similar to FIG. 17A showing the locking member rotated into a locked position with the vial sleeve.

FIG. 18A is a bottom cross-sectional view of the vial sleeve and locking member shown in FIG. 17B, showing rotation of the locking member to rotatably unlock the locking member from the vial sleeve.

FIG. 18B is a bottom cross sectional view of the vial sleeve and locking member shown in FIG. 17A, showing the locking member rotated into an unlocked position with the vial sleeve.

FIG. 19 is a partial bottom perspective view of a vial sleeve in accordance with an alternative embodiment of the vial sleeves shown in FIG. 1 and FIG. 12.

FIG. 20 is a bottom perspective view of a locking member in accordance with an alternative embodiment of the locking members shown in FIGS. 5 and 5A, and FIG. 13.

FIG. 21 is a view similar to FIG. 20 showing the locking member rotated 90° counterclockwise relative to the locking member shown in FIG. 20.

FIGS. 22A-22C are cross-sectional views of the vial sleeve shown in FIG. 19 and the locking member shown in FIGS. 20 and 21, showing sequential steps to rotatably lock the locking member with the vial sleeve.

FIG. 23A is an enlarged view of the encircled area 23A of FIG. 22A.

FIG. 23B is an enlarged view of the encircled area 23B of FIG. 22A.

FIG. 24A is an enlarged view of the encircled area 24A of FIG. 22C.

FIG. 24B is an enlarged view of the encircled area 24B of FIG. 22C.

FIG. 25 is a perspective view of an example of an embodiment of a vial sleeve for use with the lockable vial sleeve assemblies shown in FIGS. 3-24B, illustrating a top end of the vial sleeve and that excludes the vial.

FIG. 26 is a perspective view of the vial sleeve of FIG. 25, illustrating a bottom end of the vial sleeve.

FIG. 27 is a partially exploded view of a vial installation assembly for use with installation of a vial into a vial sleeve.

FIG. 28 is a partially exploded view of a mounting fixture associated with the installation assembly of FIG. 27, further illustrating an example of a vial sleeve and locking member arranged for insertion into the mounting fixture prior to locking member attachment to the vial sleeve by a locking tool, but not showing a vial for purposes of clarity.

FIG. 29 is another example of a mounting fixture associated with the installation assembly of FIG. 27.

FIG. 30 is a partially exploded view of the mounting fixture of FIG. 29, further illustrating an example of a vial sleeve, vial, and locking member arranged for insertion into the mounting fixture prior to locking member attachment to the vial sleeve.

### DETAILED DESCRIPTION OF THE INVENTION

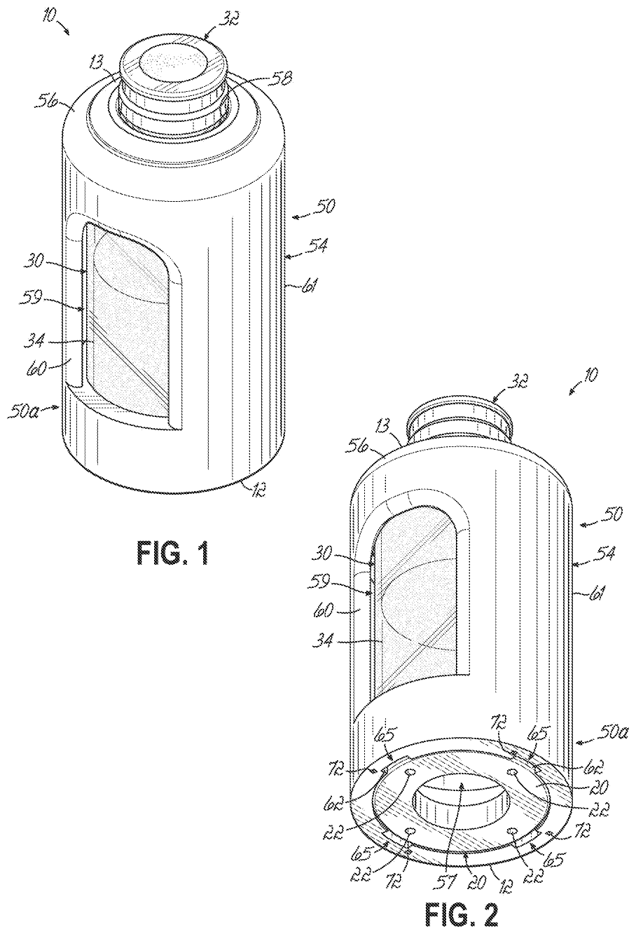

Referring now to the figures, and particularly to FIGS. 1 and 2, a lockable vial sleeve assembly 10 is shown according to one embodiment of the present invention. As shown in FIGS. 1 and 2, the lockable vial sleeve assembly 50 includes a vial sleeve 50 having a body 54, which may be generally cylindrical in cross-section, and an aperture 60 formed through a side wall 61 of the body 54. The vial sleeve 50 includes a shoulder 56 that, collectively with the side wall 61 of the body 54, define an interior space or cavity 59 for receiving a vial 30, including contents within the vial 30, such as a sample 34.

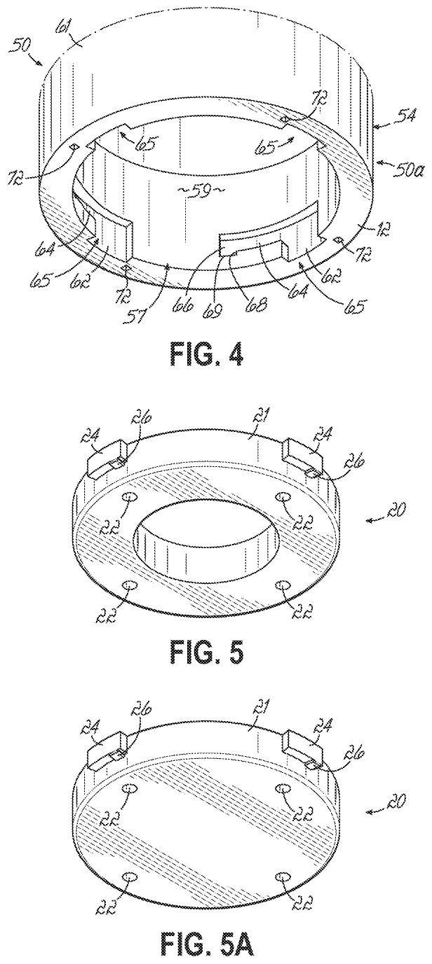

As shown in FIGS. 2 and 4, a first opening 57 is provided on one end 12 of the body 54, such as at the bottom of the vial sleeve 50, which is configured to at least partially receive the vial 30 through the opening 57 and into the vial sleeve 50. A second opening 58 may be provided on an end 13 of the body 54 opposite from the first opening 57, such as the top of the vial sleeve 50. The second opening 58 is configured to at least partially receive a cap 32 of the vial 30, which may be removably snap-fit or screw-fit onto a top of the vial 30, and at least partially allow the cap 32 to extend therethrough. In this way, the vial 30 may occupy at least a portion of, or all of, the interior space 59 of the vial sleeve 50 such that the vial 30 is at least partially housed within the vial sleeve 50, and the cap 32 may extend beyond the interior space 59 of the vial sleeve 50.

In some embodiments, the vial sleeve 50 is constructed of a material capable of withstanding cryogenic temperatures, such as between −195° C. and −150° C. The vial sleeve 50 may also include the aperture 60 to allow a user to view the contents of the vial 30 in the interior space 59, such as for visually assessing a fill level of the vial 30. The vial sleeve 50 may also be constructed of an opaque material such as to prevent a user from viewing a label or identifying indicia included on the vial 30 while the vial 30 is housed within the vial sleeve 50. While housed within the vial sleeve 50, the vial 30 may be rotatable, such as to allow a label or other identifying indicia included on the vial 30 to be selectively hidden or viewable through the aperture 60.

In one embodiment, the vial sleeve 50 may be constructed of, in a non-limiting list, polypropylene, polyether ether ketone (PEEK), Acrylonitrile butadiene styrene (ABS), polylactic acid (PLA), nylon, polycarbonate, or combinations thereof, for example.

As described herein, the depicted exemplary vials are manufactured and sold commercially by Aseptic Technologies® of Belgium, Daiichi-Sankyo®, Nunc®, or Daikyo®. For Daikyo® products, the vial may be manufactured under the tradename Crystal Zenith®.

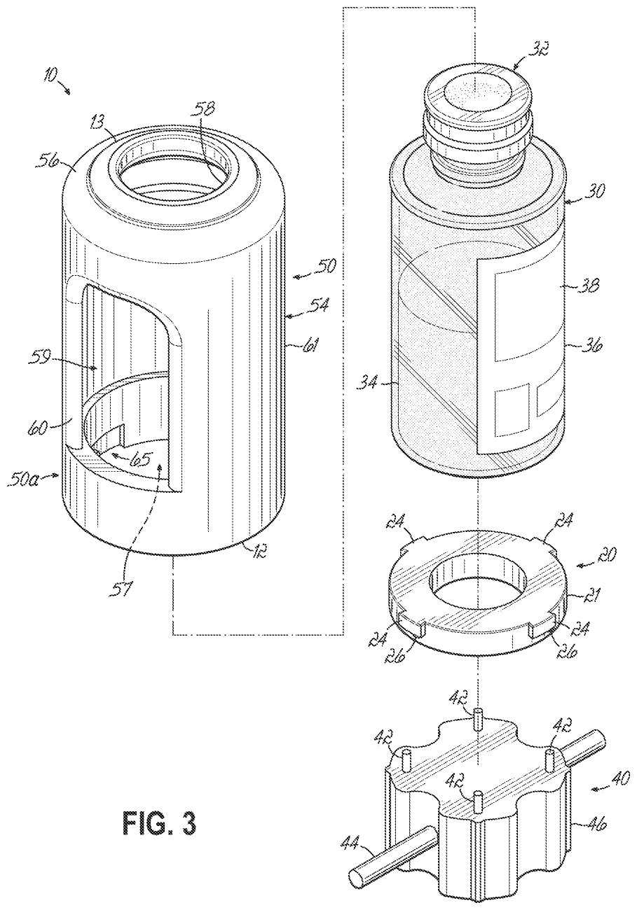

In the embodiment shown in FIGS. 1 and 2, the vial 30, including the sample 34 contained within the vial 30, is housed within the vial sleeve 50 and locked therein by a locking member 20 in a locked position. As described in detail below, FIG. 3 shows an exploded view of the lockable vial sleeve assembly shown in FIGS. 1 and 2. As shown in FIG. 3, the vial 30 may be inserted into the first opening 57 of the vial sleeve 50, cap 32 first, and then the cap 32 may be further inserted through the second opening 58 at the top of the vial sleeve 50. The vial 30 may include a label 36 printed with a set of indicia 38 adhered to the exterior surface of a side wall of the vial 30. The set of indicia 38 may include user-discernable text and/or images for visually communicating to a user a certain product or type of product, as well as machine-readable coding such as a quick response (QR) code for optically communicating similar information to a machine via a reader or scanner. The label 36 may be adhered to the exterior surface of vial 30 with a pressure sensitive adhesive at ambient temperature prior to filling of the vial 30 with the desired product in a cryogenic environment. As shown, the label 36 may wrap around a substantial portion of the exterior of the vial 30. Once inserted into the vial sleeve 50, the vial 30 may be rotated such that label 36 is selectively hidden or viewable through the aperture 60 of the vial sleeve 50.

In another application of the present invention, the vial sleeve 50 may be used to solve a labeling problem in the field. Particularly, as explained above, there is a need in the cell and gene therapy area of medicine to perform labeling of drug product (i.e., cell suspensions used in therapeutic applications are cryogenically frozen and maintained at cryogenic temperatures after they are manufactured and aliquoted in small sample volumes in vials. These vials may not be labeled specifically with needed patient information, with information that pertains to a patient, or with features that identify a particular clinical trial cohort. Furthermore, labels may be needed to specify a dose regimen based on patient weight etc., which may not be present on the vials themselves. The vial sleeve 50 may have a label applied thereon at non-cryogenic temperatures, for example at ordinary room temperatures or ambient temperature, to assure the label stays on indefinitely. Once the label is applied, the vial sleeve 50 then be placed into cryogenic temperatures and the vial 30 including a sample 34 can be inserted into the vial sleeve 50. The locking member 20 may then be applied to prevent the vial 30 from being removed from the vial sleeve 50. At least because, in this example, the vial sleeve 50 is properly labelled, the lockable vial sleeve assembly 10 may then shipped to the clinical center for administration to a patient.

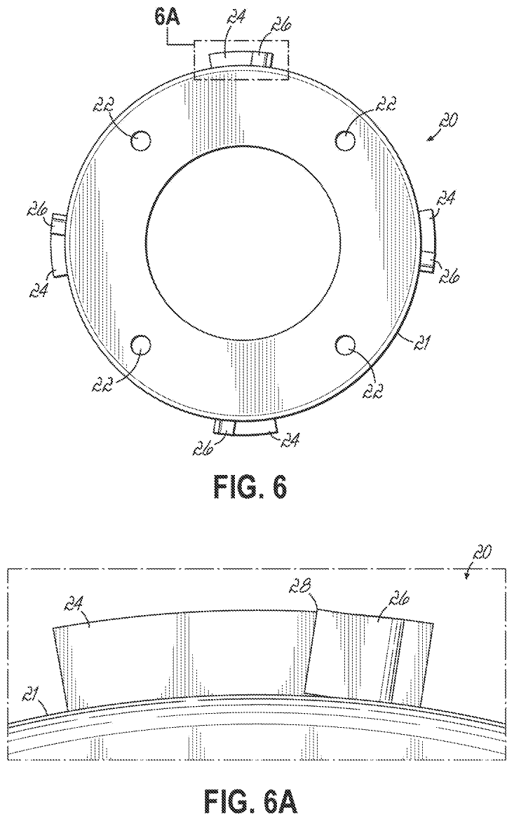

The vial 30 is locked within the vial sleeve 50 with the locking member 20. In one embodiment, the locking member 20 is an annular locking ring, as shown in FIGS. 2, 5, and 6. In another embodiment, the locking member 20 is a circular locking disc (shown in FIG. 5A). The locking member 20 at least partially closes the first opening 57 after the vial 30 is received at least partially through the first opening 57 and the locking member 20 is rotatably locked with the body 54 of the vial sleeve 50 adjacent to one end 12 of the vial sleeve 50. The locking member 20 is configured to reduce the size of the first opening 57 to be small enough to prevent the vial 30 from exiting the vial sleeve 50. Once the vial 30 is housed within the interior space 59 of the vial sleeve 50, the locking member 20 is inserted into the first opening 57 and then locked into place. In one embodiment, the locking member 20 is prevented from being rotatably disengaged from the end 12 of the body 54 of the vial sleeve 50 after the locking member 20 is rotatably locked with the body 54 adjacent to the end 12 of the vial sleeve 50. In the exemplary embodiment, the locking member 20 includes a circular locking member body having a locking member circumferential side wall 21, a plurality of key bores 22 (shown at least in FIG. 5), a plurality of locking lugs 24 extending radially outwardly from the circumferential side wall 21, and locking detents 26, which are each supported on a respective one of the locking lugs 24. As described in detail below, the locking lugs 24 and the locking detents 26 may include detent protrusions 28 (shown at least in FIG. 6A).

FIG. 3 shows a locking tool 40 that may be used to assist in rotating the locking member 20 relative to the body 54 about a longitudinal axis of the vial sleeve 50 to lock the vial 30 within the vial sleeve 50. The locking tool 40 is configured to releasably engage with the locking member 20 and is operable to rotate the locking member 20 relative to the body 54 to rotatably lock the locking member 20 with the body 54 adjacent to the end 12.

As shown in FIG. 3, the locking tool 40 includes a plurality of keys 42 that project from a base 46, and an elongated rod 44 that extends transversely from the base 46. The keys 42 that extend from the base 46 of the locking tool 40 are sized and positioned such that each key 42 can be inserted into an associated key bore 22 (shown in at least FIG. 5). Each key 42 can be configured to be inserted simultaneously into the associated key bore 22 (shown at least in FIG. 5) of the locking member 20. While four keys 42 are shown in FIG. 3, additional or fewer keys 42 may be included on the locking tool 40 so long as corresponding key bores 22 are included on the locking member 20. The elongated rod 44 extends from the base 46 in a direction generally perpendicular to the keys 42. The elongated rod 44 may be a single rod positioned in a bore through the base 46, separate rods each attached to and extending from an exterior surface of the base 46, or some other orientation. During locking of the locking member 20 to the vial sleeve 50, a user may use the arms formed by the elongated rod 44 to provide leverage and assist with rotating of the locking member 20. A detailed method of using the locking tool 40 to lock the vial 30 within the vial sleeve 50 is described below.

Referring to FIGS. 4-6A, FIG. 4 shows a bottom portion 50A of vial sleeve 50 for clarity. The bottom portion 50A of the body 54 includes at least one of a first locking feature 65 formed in an inner surface of the body 54 adjacent to the end 12. The first locking feature 65, in one embodiment, is defined by a recess entrance 62, recess channel 64, and recess lock 66. The recess channel 64 extends horizontally from the recess entrance 62 to the recess lock 66. The recess channel 64 is narrower than the recess lock 66 by a length of wall 68. The first locking features 65 are provided adjacent to the end 12 of the bottom portion 50A of the body 54. The bottom portion 50A further includes indicia 72, whose function will be described below.

FIG. 5 shows the locking member 20 separated from the other components of the lockable vial sleeve assembly 10. The view of the locking member 20 shown in FIG. 5 includes the key bores 22 which are sized and positioned to simultaneously receive each of the keys 42 (shown in FIG. 3) of the locking tool 40. The locking member 20 includes, in one embodiment, a second locking feature extending radially outwardly from the circumferential sidewall 21 of the locking member 20. The second locking feature, in one embodiment, is defined by the locking lugs 24 extending radially outwardly from the circumferential side wall 21, the locking detents 26 extending axially downwardly from the locking lug 24, and the detent protrusions 28 extending from the locking detents 26 beyond an outer radius of the locking lug 24. The vial sleeve 50 may be locked, with the vial 30 locked therein, by inserting the locking lugs 24 into the recess entrances 62 located on the vial sleeve 50. The locking lugs 24, in an embodiment, are configured to cooperate with the first locking feature 65 to rotatably lock the locking member 20 with the body 54 adjacent to the end 12. The locking member 20 is rotatably locked with the body 54 at the end 12 in response to relative rotation of the locking member 20 and the body 54. In an embodiment, the locking member 20 is rotatably locking with the body 54 adjacent the end 12 in response to rotation of the locking member 20 relative to the body 54.

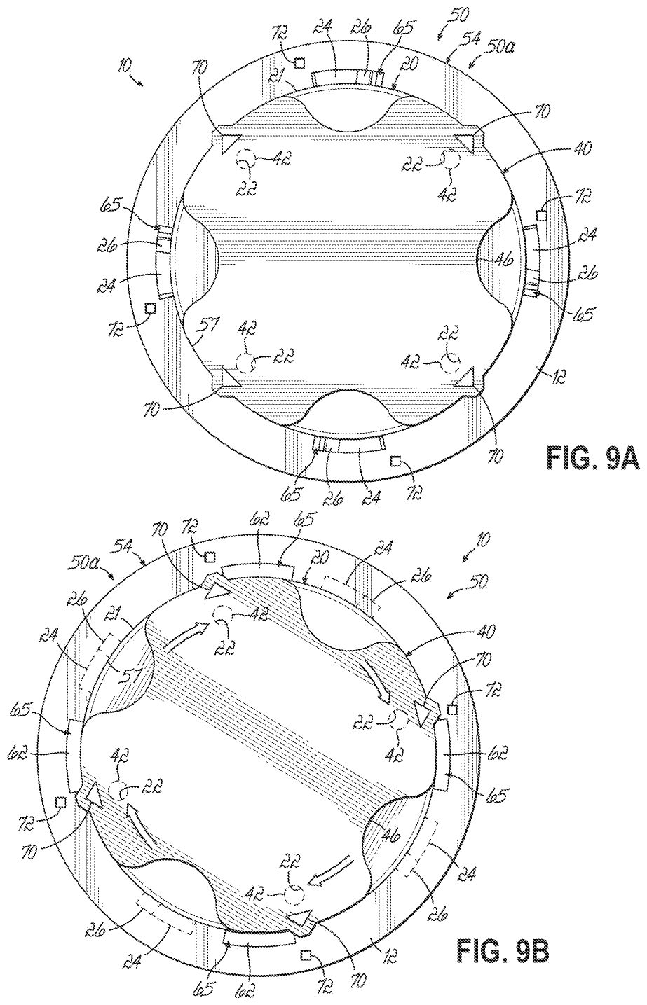

Recess entrances 62 are sized and positioned to receive locking lugs 24 simultaneously. While four such locking lugs 24 are shown, either fewer or more locking lugs 24 may be used, preferably at equal angular displacements around the locking member 20. Furthermore, the locking lugs 24 each include a locking detent 26 which further includes a detent protrusion 28. The detent protrusion 28, as shown in FIG. 6A, extends slightly beyond the exterior radius of the locking lug 24. Once inserted into the recess entrances 62, the locking member 20 may be rotated, causing each of the locking lugs 24 to travel through a respective recess channel 64, and eventually, each of the locking lugs 24 may be positioned in a recess lock 66. The detent protrusion 28 is angled so as to allow the locking lug 24 to travel through the recess channel 64 and eventually to the recess lock 66. Once each of the locking lugs 24 is positioned within a recess lock 66, a recess lock bottom wall 69 prevents the locking member 20 from axially moving to separate itself from the vial sleeve 50. In addition, the locking lugs 24 of the locking member 20 are prevented from reversing back through the recess channel 64 by recess wall 68, which contacts the locking detent 26, and the angled detent protrusion 28, included on the locking lugs 24. The illustrated embodiment shows that the locking member 20 is rotated clock-wise when viewed from the bottom of vial sleeve 50, such as in the view shown in FIGS. 9A and 9B, however, other rotational orientations are possible. For example, in another embodiment, not shown, the locking member 20 is rotated counter clock-wise when viewed from the bottom of vial sleeve 50.

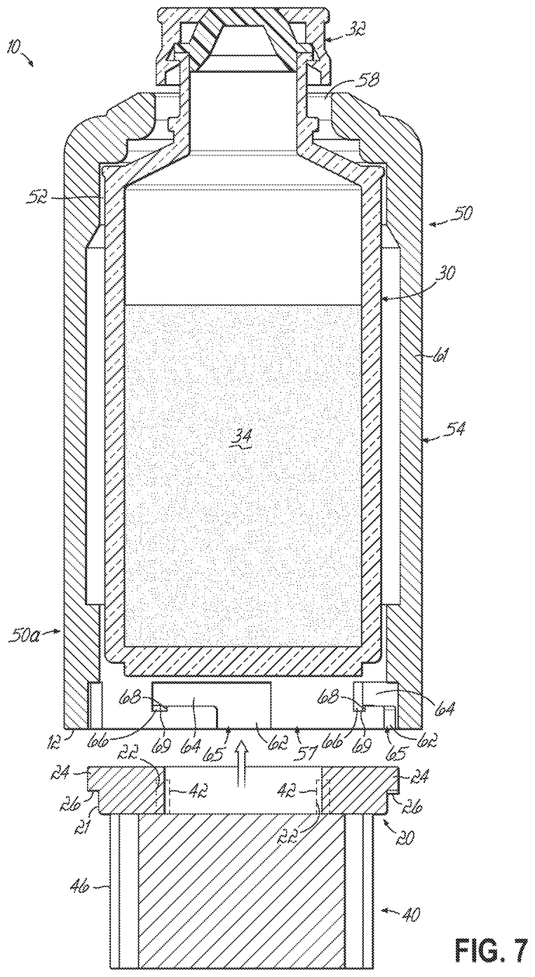

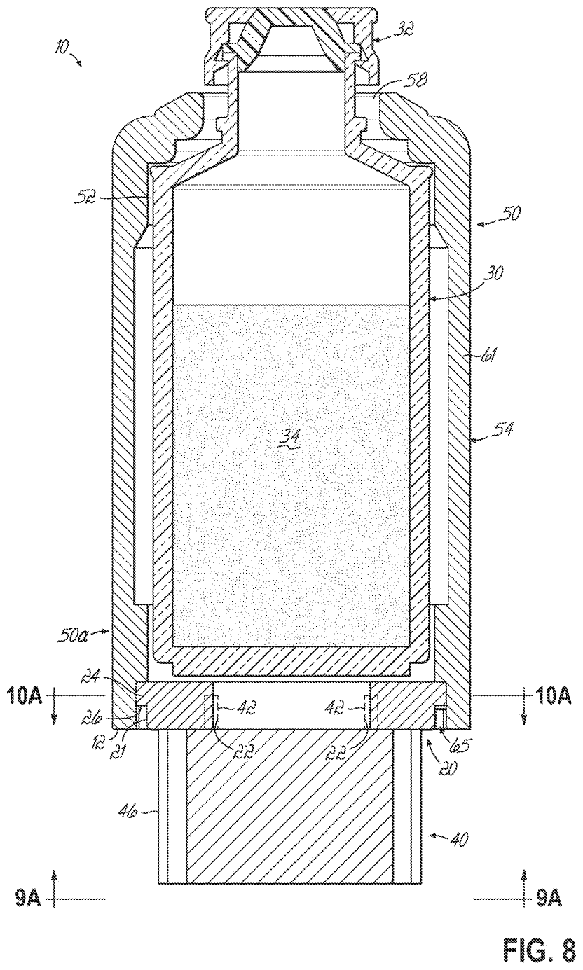

In some applications of the lockable vial sleeve assembly 10, the components are maintained or used at temperatures that may be hazardous for humans to touch, such as at cryogenic temperatures, without safety equipment. To reduce hazardous environments and to assist in locking the vial 30 within the vial sleeve 50, the locking tool 40 may be used to insert the locking lugs 24 into the recess entrances 62 and to rotate the locking member 20 once the locking lugs 24 are inserted into their respective recess entrances 62. To do this, as shown in FIGS. 7-8 the keys 42 on the locking tool 40 are each simultaneously inserted into individual key bores 22 included on the locking member 20. FIG. 7 shows the keys 42 of the locking tool 40 having been inserted into the key bores 22, but before the locking lugs 24 are inserted into the recess entrances 62. In another embodiment, not shown, the locking lugs 24 are inserted into the recess entrances 62 prior to the keys 42 being inserted into the key bores 22. In any event, each of the locking lugs 24 is inserted into a respective recess entrance 62, as shown in FIG. 8.

There is a space 52 present between vial 30 and the vial sleeve 50, as shown in FIGS. 7 and 8 once the vial 30 is housed within the vial sleeve 50. This space 52 is sized and configured to allow the vial sleeve 50 and/or vial 30 to thermally contract or expand due to changes in temperature, such as a change from room temperature to cryogenic temperature, or vice versa. At least because the space 52 is present, thermal expansion or contraction of the vial sleeve 50 and/or vial 30 does not result in damaging either the vial sleeve 50 or the vial 30. Furthermore, space 52 may serve as an access space configured to allow a thawing fluid (not shown) to contact a significant portion of the vial 30, such as 75% to 80% of the surface of vial 30, directly. By allowing a thawing fluid to contact the surface of vial 30 directly, rapid thawing of the vial 30 sample 34 may be achieved. Furthermore, space 52 may be used with a forced fluid delivery system in order to accommodate rapid thawing. Accordingly, the vial sleeve 50 may serve not only to provide space for labelling at non-cryogenic temperatures or an opaque area for hiding a label that is placed on the vial 30, but may also provide rapid thawing capabilities, such as when coupled to a means for providing positive pressure fluid/air flow.

Referring to FIGS. 9A and 9B, the bottom of the lockable vial sleeve assembly 10 with the locking tool 40 still inserted into the locking member 20 is shown. The locking tool 40 includes locking tool indicia 70 etched, printed, or otherwise marked thereon. Similarly, the bottom of vial sleeve 50 includes sleeve indicia 72 etched, printed, or otherwise marked thereon. The keys 42 on the locking tool 40 and the key bores 22 on the locking member 20 are positioned such that the locking tool indicia 70 and the sleeve indicia 72 will be aligned when the locking lugs 24 are positioned within the recess locks 66, and the locking tool indicia 70 and the sleeve indicia 72 will not be aligned when the locking lugs 24 are not positioned within the recess locks 66. As shown in FIG. 9A, the locking tool indicia 70, and the sleeve indicia 72 are not aligned. This orientation indicates that the locking member 20 has not yet been locked into place, and the locking lugs 24 are not yet positioned within the recess locks 66. Conversely, as shown in FIG. 9B, the locking tool indicia 70, and the sleeve indicia 72 are aligned. This orientation indicates that the locking member 20 has been locked into place, and the locking lugs 24 are positioned within the recess locks 66.

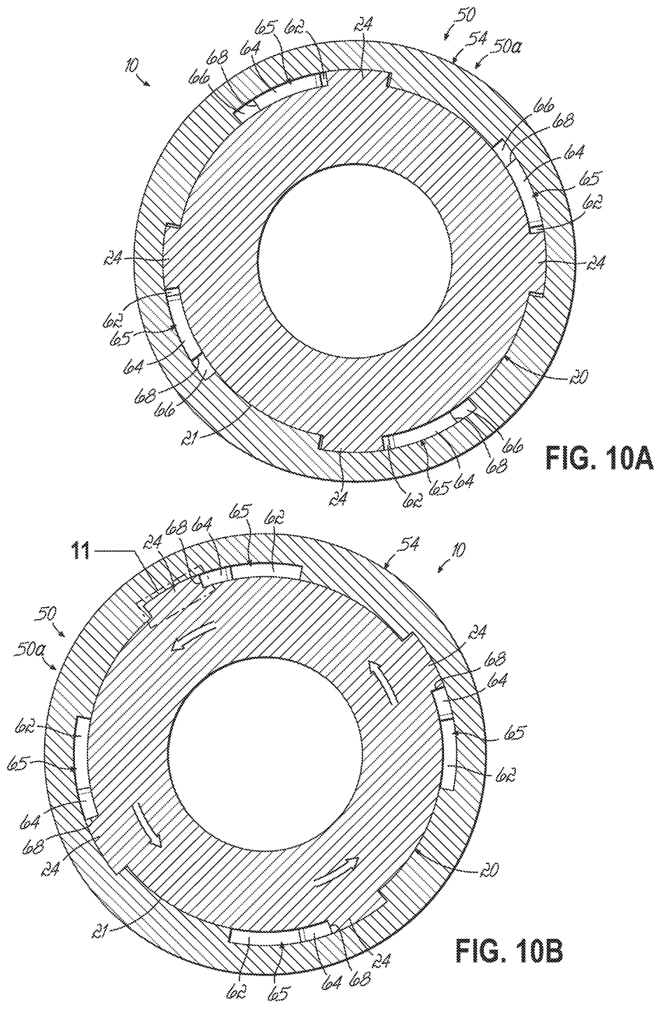

Referring to FIGS. 10A and 10B, a cross section of the lockable vial sleeve assembly 10 with locking tool 40 still inserted into the locking member 20 is shown. FIGS. 10A and 10B refer to the same orientation as shown in FIGS. 9A and 9B, respectively. As shown in FIG. 10A, the locking lugs 24 are not yet positioned in recess locks 66, and accordingly, the locking member 20 has not yet been locked into place. However, as shown in FIG. 10B, the locking member 20 may be rotated from its position shown in FIG. 10A, and the locking lugs 24 are positioned within the recess locks 66. In this way, the locking member 20 prevents the vial 30 from exiting from within the interior space 59 of the vial sleeve 50.

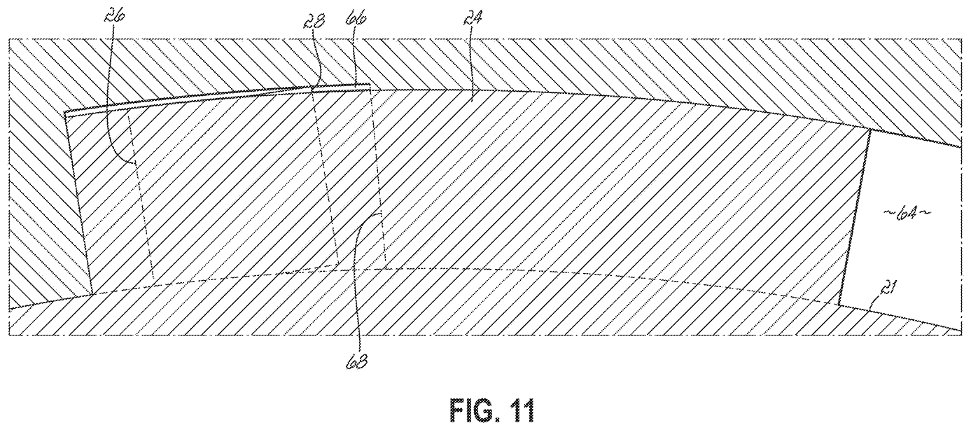

Referring to FIG. 11, an enlarged view of the locking lug 24, including the locking detent 26, is shown. In FIG. 11, the locking lug 24 is positioned within a recess lock 66, and the vial sleeve 50 has accordingly been locked. As shown in FIG. 11, the locking detent 26 and the detent protrusion 28 assist in keeping the locking lug 24 within the recess lock 66, and prevent the locking lug 24 from travelling into the recess channel 64. In this way, locking lug 24 is maintained within the recess lock 66, and the locking member 20 provides a barrier preventing the vial 30 from exiting the vial sleeve 50. In an embodiment, there is no means by which the locking lug 24 leaves the recess lock 66, and the locking member 20 is permanently, and irreversibly, coupled to the vial sleeve 50 without damaging or destroying the vial sleeve 50 and/or locking member 20. In another embodiment, an unlocking tool (not shown) may be used to reverse the locking process, and release locking member 20 from the recess lock 66.

In an example of a method of using the lockable vial sleeve assembly 10, the vial sleeve locking process may occur at a first location where vial 30 containing sample 34 may be locked into vial sleeve 50, and sample 34 may be frozen at or around the time of locking the vial 30 in the vial sleeve 50. At a second location, such as a clinic, a nurse/physician may follow a thawing procedure to bring the frozen sample 34 to liquid, and may aspirate the sample 34 into, for example, a syringe and then into a patient (either directly or via an IV).

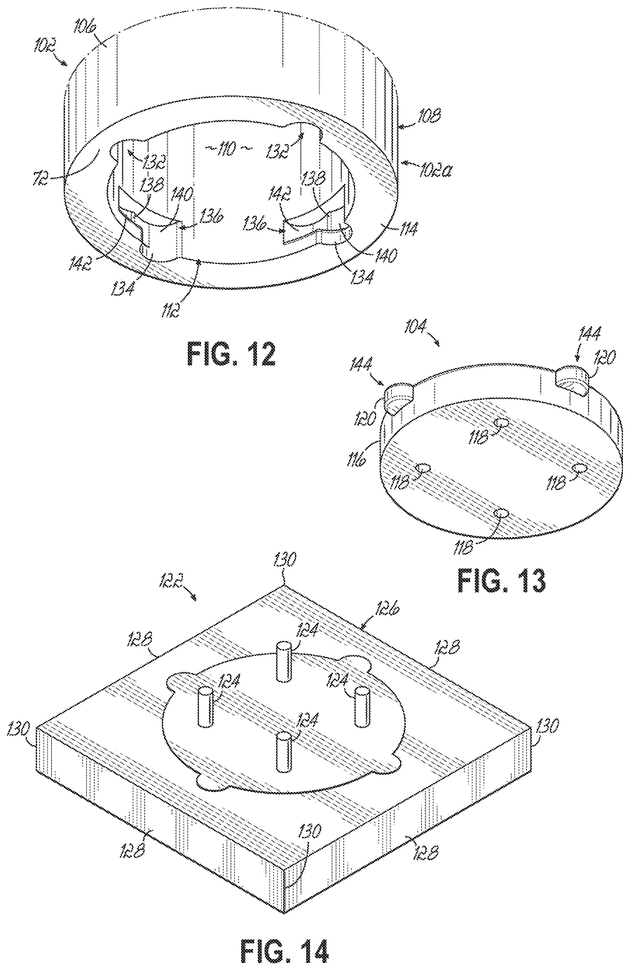

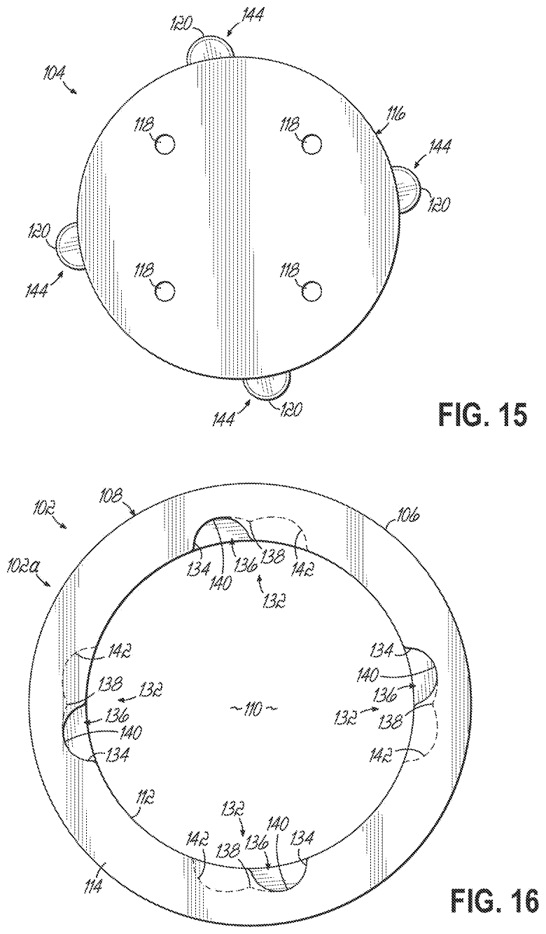

Referring now to FIGS. 12-13 and 15-16, an alternative embodiment of a lockable vial sleeve assembly 100 is shown including a vial sleeve 102, with a bottom portion of the vial sleeve 102 shown in FIGS. 12 and 16, and a locking member 104 shown in FIGS. 13 and 15.

In this embodiment, the vial sleeve 102 has a body 106 which, similar to the vial sleeve 50 described above, may be generally cylindrical in cross section and include an aperture (not shown) formed through a side wall 108 of the body 106. As with the vial sleeve 50 described above, the vial sleeve 102 includes a shoulder (not shown) that collectively, with the side wall 108 of the body 106, defines an interior space or cavity 110 for receiving a vial (not shown), similar to the vial 30 described above. The vial sleeve 102 and locking member 104 provide the same function and result as the vial sleeve 50 and locking member 20 described above to rotatably lock the vial (not shown) within the cavity 110 of the vial sleeve 102.

As shown in FIGS. 12 and 16, a first opening 112 is provided on one end 114 of the body 106, such as the end of the vial sleeve 102 which is configured to at least partially receive the vial (not shown) through the opening 112 and into the vial sleeve 102. While not shown in FIGS. 12-16, a second opening may be provided on an end of the body 106 opposite from the first opening 112, such as the top of the vial sleeve 102, similar to the lockable vial sleeve assembly 10 described in detail above. As described above, the second opening (not shown) is configured to at least partially receive a cap of the vial and at least partially allow the cap to extend therethrough such that the vial is at least partially housed within the vial sleeve 102, and the cap may extend beyond the interior space 110 of the vial sleeve 102.

Similar to the lockable vial sleeve assembly 10 as described above, a vial (not shown) is locked within the vial sleeve 102 with the locking member 104 rotatably locked to the end 114 of the vial sleeve 102. As shown in FIGS. 13 and 15, the locking member 104 is a circular locking disc in one embodiment, although the locking member may comprise an annular locking ring in an alternative embodiment (not shown). The locking member 104, similar to the locking member 20 described above, is configured to at least partially close the first opening 112 after a vial is received at least partially through the first opening 112 and the locking member 104 is rotatably locked with the body 106 of the vial sleeve 102 adjacent to the end 114 of the vial sleeve 102.

Similar to the lockable vial sleeve assembly 10 described in detail above, once a vial is housed within the interior space 110 of the vial sleeve 102, the locking member 104 is inserted into the first opening 112 and then rotatably locked into place. The locking member 104 may be prevented from being rotatably disengaged from the end 114 of the body 106 of the vial sleeve 102 after the locking member is rotatably locked with the body 106 adjacent to the end 114 of the vial sleeve 102.

As shown in FIGS. 13 and 15, the locking member 104 includes a circular locking member body having a locking member circumferential side wall 116, a plurality of key bores 118, and locking lugs 120 extending radially outwardly from the circumferential side wall 116.

Referring now to FIG. 14, a locking tool 122 may be used to assist in rotating the locking member 104 relative to the body 106 about a longitudinal axis of the vial sleeve 102 to lock the vial (not shown) within the vial sleeve 102. As with the locking tool 40 described above, the locking tool 122 is configured to releasably engage with the locking member 104 and is operable to rotate the locking member 104 relative to the body 106 to rotatably lock the locking member 104 with the body 106 adjacent to the end 114.

As shown in FIG. 14, the locking tool 122, similar to the locking tool 40 described above, includes a plurality of keys 124 which project from a base 126. Each key 124 is sized to be removably received by an associated key bore 118. In addition, the plurality of keys 124 are configured to be simultaneously inserted into an associated key bore 118 of the locking member 104. While four keys 124 are shown in FIG. 14, additional or fewer keys 124 may be included on the locking tool 122 along with corresponding key bores 118 included on the locking member 104. In the exemplary embodiment of the locking tool 122 shown in FIG. 14, the locking tool 122 may be square-shaped to include four gripping sides 128 which define four gripping corners 130 to assist a user with manually rotating the locking tool 122, and thus the locking member 104.

Referring now to FIGS. 12 and 16-18, the bottom portion 102A of the vial sleeve 102 and the locking member 104 are shown for rotatably locking a vial (not shown) within the lockable vial sleeve assembly 100.

As shown in FIGS. 12 and 16-18, the bottom portion 102A of the body 106 includes at least one first locking feature 132 formed in an inner surface of the body 106 adjacent to the end 114. According to one embodiment, the first locking feature 132 is defined by a recess entrance 134, a recess channel 136, and a locking detent 138 extending axially inwardly into the recess channel 136. As shown in FIGS. 16-18, the recess channel 136 includes a first recess lobe 140 in communication with the recess entrance 134 on one side of the locking detent 138, and a second recess lobe 142 located on an opposite side of the locking detent 138. The recess channel 136 extends horizontally from the first recess lobe 140 to the second recess lobe 142, with the axial width of the recess channel 136 being reduced or narrowed at the locking detent 138 disposed between the first recess lobe 140 and the second recess lobe 142. It should be appreciated that the first recess lobe 140 can be referred to as an insertion lobe 140, and the second recess lobe 142 can be referred to as a locking lobe 142.

As shown in FIGS. 13, 15 and 17-18, the locking member 104 includes, in one embodiment, a second locking feature 144 extending radially outwardly from the circumferential side wall 116 of the locking member 104. The second locking feature 144, in one embodiment, is defined by the locking lug 120 extending radially outwardly from the circumferential side wall 116. The vial sleeve 102 may be locked, with a vial (not shown) locked therein, by inserting the locking lugs 120 into the recess entrances 134 located on the vial sleeve 102. The locking lugs 120, in one embodiment, are configured to cooperate with the first locking feature 132 to rotatably lock the locking member 104 with the body 106 adjacent to the end 114 in response to relative rotation of the locking member 104 and the body 106. In one embodiment, the locking member 104 is rotatably locked with the body 106 adjacent to the end 114 in response to rotation of the locking member 104 relative to the body 106.

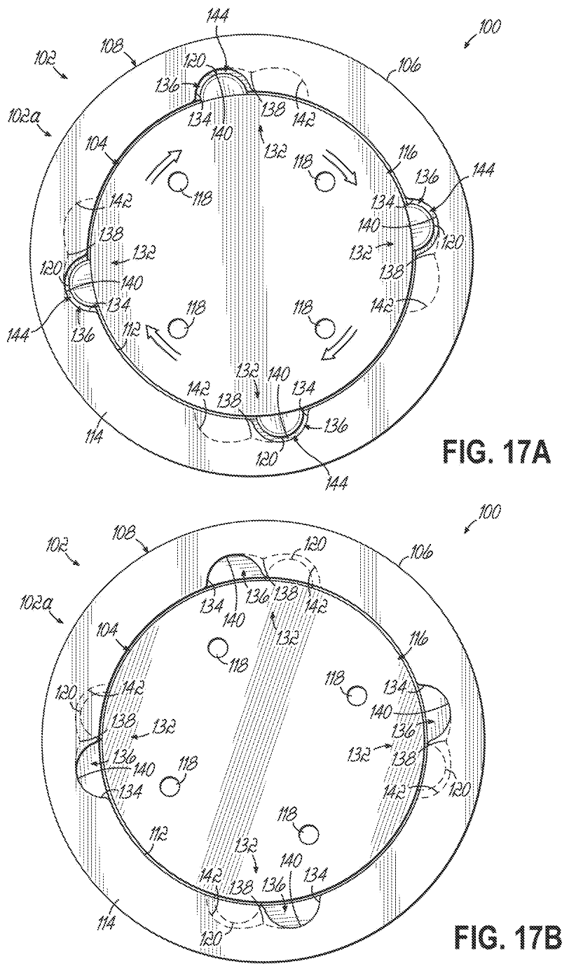

Similar to the recess entrances 62 described in detail above, the recess entrances 134 are sized and positioned to receive the locking lugs 120 simultaneously. While four such locking lugs 120 are shown, either fewer or more locking lugs 120 may be used, preferably at equal angular displacement surround the locking member 104. Once inserted into the recess entrances 134 as shown in FIG. 17A, the locking member 104 may be rotated, causing each of the locking lugs 102 to travel through a respective recess channel 136 from the first recess lobe 140 to the second recess lobe 142 as shown in FIG. 17B.

As the locking lugs 120 travel through the respective recess channels 136, the locking lugs 120 initially engage the respective locking detents 138, and thereafter pass to the respective second recess lobes 142 after passing the locking detents via a “snap-fit” so as to rotatably lock the locking member 104 to the vial sleeve 102. As illustrated, the locking member 104 is rotated in a first direction, or clock-wise when viewed from the bottom of the vial sleeve 102, such as in the view shown in FIG. 17A. However, other rotational orientations are possible as well.

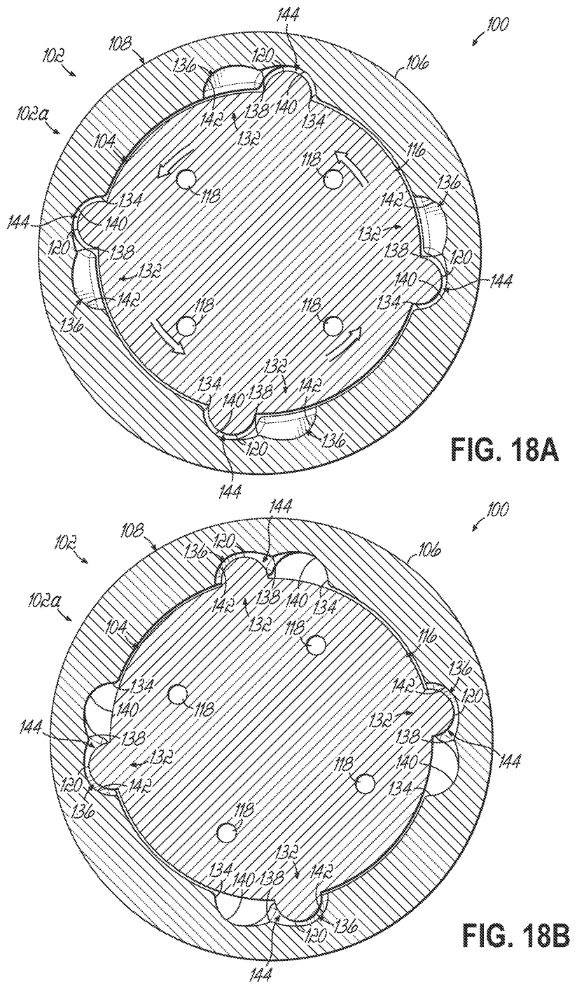

As shown in FIGS. 18A and 18B, the locking member 104 may be rotated in a second direction, or counter clock-wise with the locking tool 122, when viewed from the bottom of the vial sleeve 102, so as to rotatably unlock the lockable vial sleeve assembly 100 when necessary or desired. In the illustrated embodiment, the locking lugs 120 have an arcuate or curved shape (or curved perimeter), while the lobes 140, 142 have a complimentary arcuate or curved shape (or curved perimeter). In other examples of embodiments, the locking lugs 120 can have any suitable shape that is complimentary to the shape of the lobes 140, 142 to facilitate insertion and locking/unlocking operation as discussed herein.

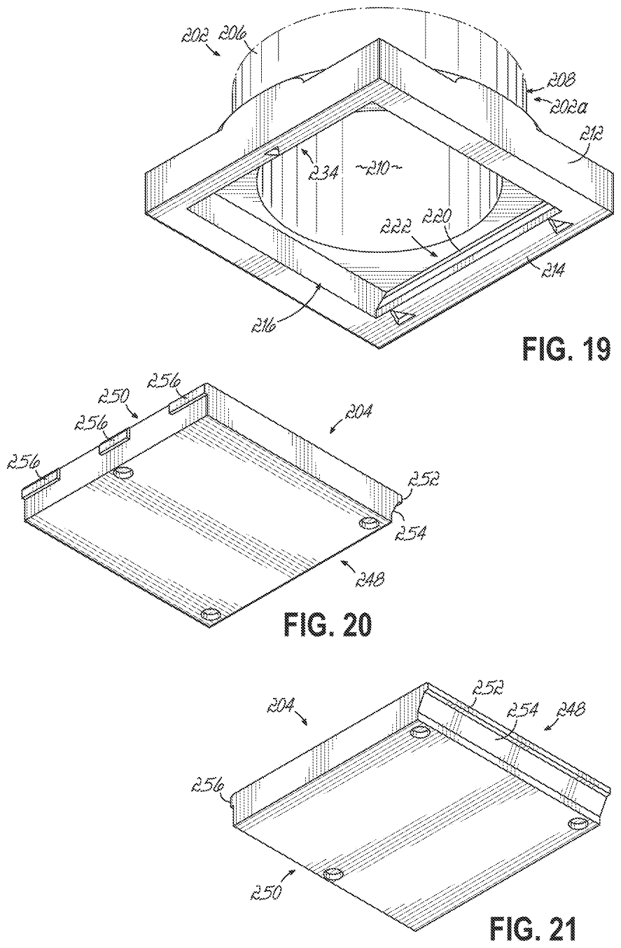

Referring now to FIGS. 19-23, another example of an embodiment of a lockable vial sleeve assembly 200 is shown. In this embodiment, the lockable vial sleeve assembly 200 includes a vial sleeve 202, with a bottom portion of the vial sleeve shown in FIGS. 19, 22A-22C and 23A-23C, and a locking member 204 shown in FIGS. 20-23.

As with the other vial sleeve embodiments described in detail above, the vial sleeve 202 of this embodiment may also be generally cylindrical in cross-section at least partially along its longitudinal length and include an aperture (not shown) formed through a side wall 206 of the body 208 of the vial sleeve. The vial sleeve 202 of this embodiment, similar to the vial sleeve embodiments described above, includes a shoulder (not shown) that collectively, with the side wall 206 of the body 208, defines an interior space or cavity 210 for receiving a vial (not shown) similar to the vial 30 described above. As with the other vial sleeve and locking member embodiments described above, the vial sleeve 202 and locking member 204 of this embodiment provides the same function and result as those other embodiments to rotatable lock the vial (not shown) within the cavity 210 of the vial sleeve 202.

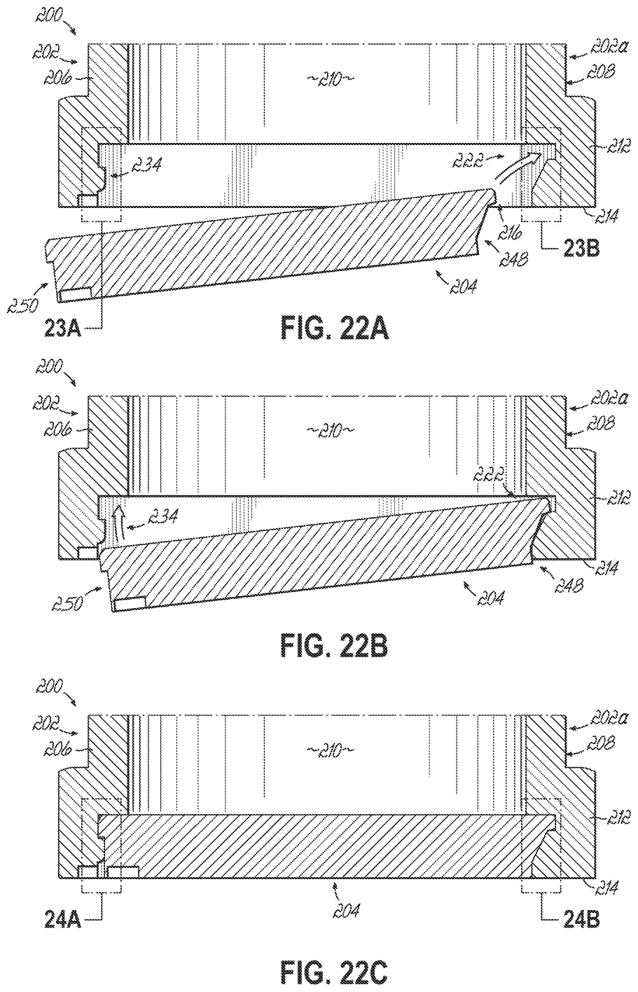

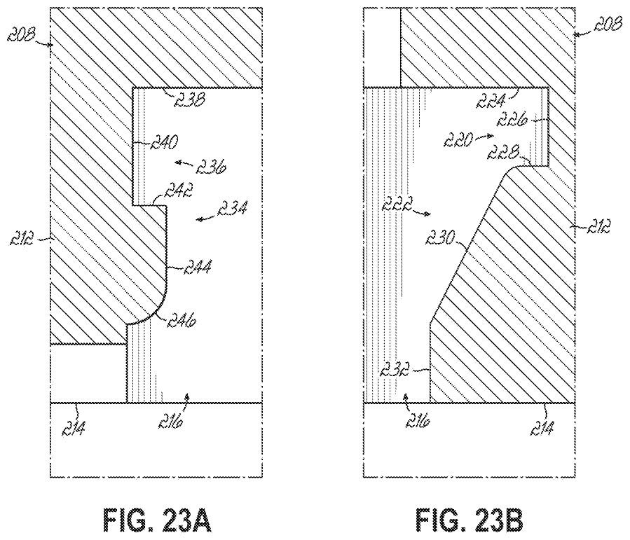

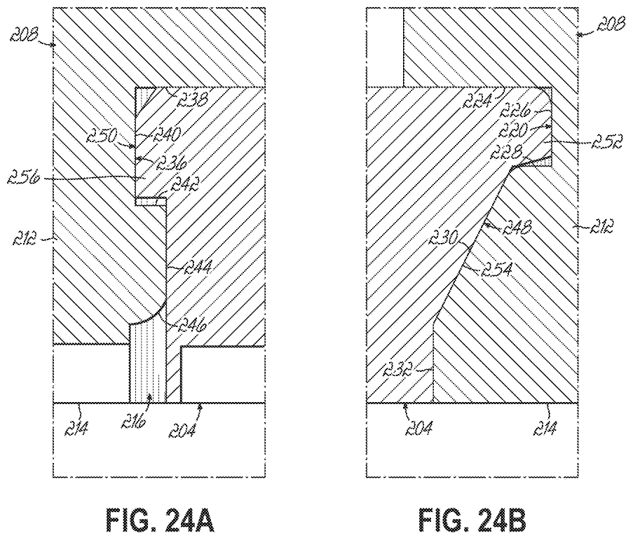

In this embodiment of the lockable vial sleeve assembly 200, the vial sleeve 202 differs from the vial sleeve embodiments described above as the side wall 206 of the body 208 terminates at a base 212. As shown in FIGS. 19 and 22A-C, the base 212 extends outwardly from the generally cylindrical body 208 of the vial sleeve 202 at one end 202A of the vial sleeve 202. The base 212 defines a plurality of linear surfaces. In the illustrated embodiment, the linear surfaces of the base 212 are oriented into a rectangular or square base 212. In other examples of embodiments, the base 212 can be any suitable geometry that includes a plurality of linear surfaces. The linear surfaces can assist with limiting rotation of the vial sleeve 202 during attachment of the locking member 204 to the vial sleeve 202, as discussed in additional detail below. The base 212 can also provide additional support and stability to the lockable vial sleeve assembly 200.

As shown in FIG. 19, the base 212 defines a rectangular or square first opening 216 on the end 214 of the body 208, such as the end of the vial sleeve 202 which is configured to at least partially receive the vial (not shown) through the opening 216 and into the vial sleeve 202. In this embodiment, while not shown in FIGS. 19 and 22, a second opening may be provided on an end of the body 208 opposite from the first opening 216, such as the top of the vial sleeve 202, similar to the lockable vial sleeve assembly embodiments described in detail above. As described above, the second opening (not shown) is configured to at least partially receive a cap of the vial and at least partially allow the cap to extend therethrough such that the vial is at least partially housed within the vial sleeve 202, and the cap may extend beyond the interior space 210 of the vial sleeve 202.

Similar to the lockable vial sleeve assembly embodiments as described above, a vial (not shown) is locked within the vial sleeve 202 with the locking member 204 rotatably locked to the end 202A of the vial sleeve 202. As shown in FIGS. 20-22, the locking member 204 may be a generally rectangular or square locking plate in one embodiment. The locking member 204, similar to the locking member embodiments described above, is configured to at least partially close the first opening 216 after a vial is received at least partially through the first opening 216 and the locking member 204 is rotatably locked with the body 208 of the vial sleeve 202 adjacent to the end 214 of the vial sleeve 202.

As shown in the exemplary embodiments of FIGS. 19 and 22-23, the first opening 216 is provided with an elongated first locking channel 220 that extends horizontally along one side 222 of the first opening 216. In the exemplary embodiment as shown in FIGS. 22A-C and 23B, the first locking channel 220 is defined by a horizontal top wall 224, a vertical side wall 226, and a horizontal bottom wall or shelf 228 that is spaced from and confronts the top wall 224. The first locking channel 220 is spaced (or recessed) relative to the first end 216. The base 212 of the vial sleeve 202 includes a chamfered wall 230 that extends inwardly and downwardly from the bottom wall or shelf 228 to a vertical side wall 232 of the first opening 216 that extends along the one side 222 of the first opening 216.

As shown in FIGS. 22A-22C and 23A, the opposite side 234 of the first opening 216 is provided with an elongated second locking channel 236 that extends horizontally along the opposite side 234 of the first opening 216. The second locking channel 236 is spaced (or recessed) relative to the first end 216 (or first opening 216). In the exemplary embodiment as shown in FIGS. 22A-22C and 23A, the second locking channel 236 is defined by a horizontal top wall 238, a vertical side wall 240, and a horizontal bottom wall or shelf 242 that is spaced from and confronts the top wall 238. The base 212 of the vial sleeve 202 includes a vertical wall 244 that is positioned inwardly from the vertical side wall 240 of the elongated second locking channel 236 and extends to an elongated radius 246 that extends along the opposite side 234 of the first opening 216.

Referring now to FIGS. 21, 22A-22C and 23A-23B, the locking member 204 includes one side 248 that is configured to engage and be received within the elongated first locking channel 220, and an opposite side 250 that is configured to rotatably lock (or pivotably lock) with the elongated second locking channel 236.

As shown in FIGS. 21, 22A-22C and 23B, the one side 248 of the locking member 204 that is configured to engage and be received within the elongated first locking channel 220 includes an elongated first locking tab 252 that extends horizontally along the one side 248 of the locking member 204. The first locking tab 252 projects away (or extends horizontally outwardly) from a first side 248 of the locking member 204. The one side 248 of the locking member also includes a chamfered wall 254 (or a curved wall 254) that is complimentary in shape to the chamfered wall 230 (or a curved wall 230) provided on the one side 222 of the first opening 216.

As shown in FIGS. 20, 22A-22C and 23A, the opposite side 250 (or second side 250) of the locking member 204 that is configured to rotatably lock with the elongated second locking channel 236 includes a plurality (or multiple) spaced second locking tabs 256 that extend horizontally outwardly along the opposite side 250 of the locking member 204. While three spaced second locking tabs 256 are shown in the exemplary embodiment of FIG. 20, the number of locking tabs 256 may vary in other embodiments. For example, in alternative examples of embodiments, the locking member 204 can include a single elongated second locking tab 256 provided on the opposite side 250 of the locking member 204.

Referring now to FIGS. 22A-22C and 23A-23B, once a vial (not shown) is housed within the interior space 210 of the vial sleeve 202, the locking member 204 is inserted into the first opening 216 and then rotatably locked into place. The locking member 204 may be prevented from being rotatably disengaged from the end 214 of the body 208 of the vial sleeve 202 after the locking member 204 is rotatably locked with the body 208 adjacent to the end 214 of the vial sleeve 202. While not shown, an apparatus may be provided to assist in rotatably locking the locking member 204 with the vial sleeve 202 after the vial (not shown) has been inserted into the cavity 210 of the vial sleeve 202.

To rotatably lock the locking member 204 with the vial sleeve 202, the locking member 204 is first inserted into the first opening 216 to engage the first locking tab 252 provided on the one side 248 of the locking member 204 with the elongated first locking channel 220 provided on the one side 222 of the first opening 216 as shown in FIGS. 22A and 22B. Thereafter, the opposite side 250 of the locking member 204 is rotated upwardly as shown in FIG. 22B until the three locking tabs 256 provided on the opposite side 250 of the locking member 204 first engage the radius 246, and then transition over the radius and are received within the elongated second locking channel 236 provided on the opposite side 234 of the first opening 216 as shown in FIGS. 22C and 23A. In one embodiment, the locking member 204 is rotatably locked with the body 208 adjacent to the end 214 in response to rotation of the locking member 204 relative to the body 208.

In the locked position as shown in FIGS. 22C and 23A-23B, the locking member 204 at least partially closes the first opening 216 to lock the vial (not shown) within the lockable vial sleeve assembly 200.

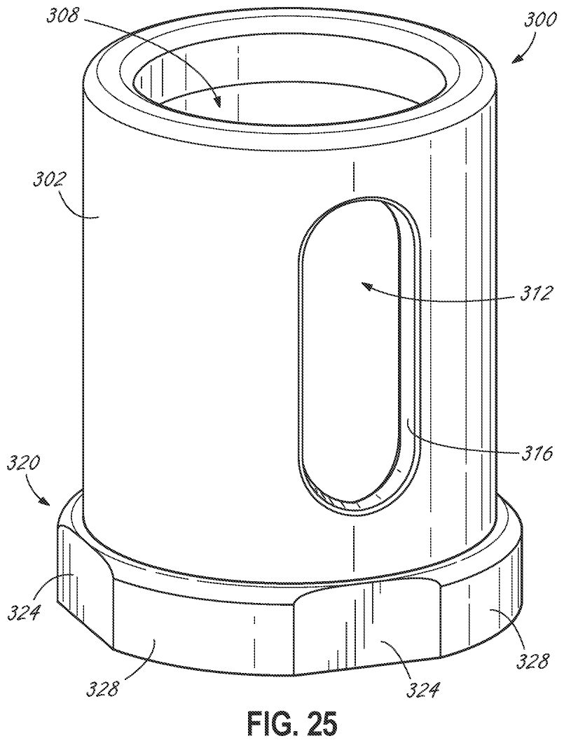

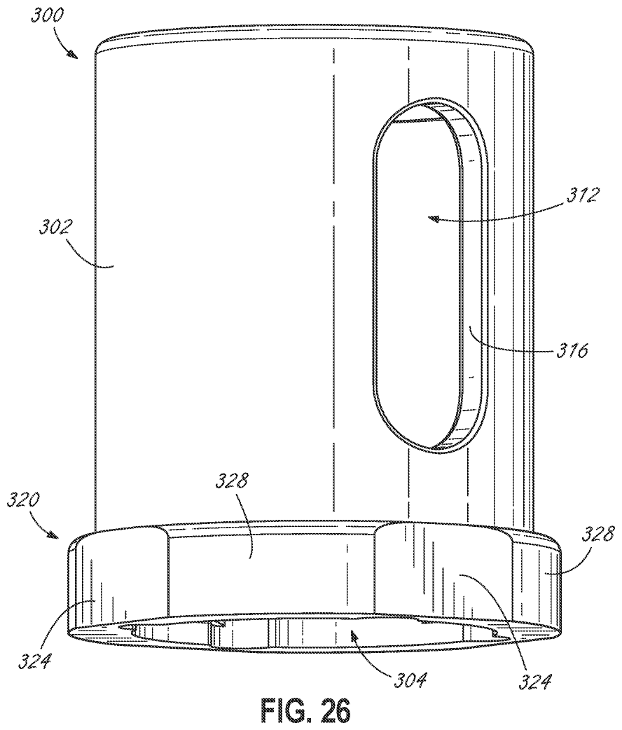

With reference now to FIGS. 25-26, another example of an embodiment of a lockable vial sleeve assembly 300 is illustrated. One of more components of the vial sleeve assembly 300 can be used in association with any of the embodiments of the lockable vial sleeve assemblies 10, 100, 200 discussed above. The vial sleeve assembly 300 includes a vial sleeve 302 (or sidewall 302 or a body 302), a first opening 304 (or a bottom opening 304 or a vial insertion opening 304) (shown in FIG. 26), and a second opening 308 (shown in FIG. 25). The first opening 304 is positioned opposite the second opening 308 (shown in FIG. 25). The first opening 304 has a cross-sectional diameter that is greater than the second opening 308. Stated another way, the second opening 308 is smaller than the first opening 304. This facilitates insertion and retention of the vial 30 (shown in FIG. 3) within the vial sleeve assembly 300. More specifically, the vial 30 (shown in FIG. 3) can be inserted into the first opening 304 with the cap 32 (and/or a neck) of the vial 30 extending through the second opening 308. The vial sleeve 302 defines a cavity 312 between the openings 304, 308 within which the vial 30 (shown in FIG. 3) is received. An internal shoulder of the vial sleeve 302 can contact a bell or shoulder of the vial 30. The vial sleeve 302 can also include a sidewall aperture 316 (or sidewall window 316 or sidewall opening 316) through which the vial 30 (shown in FIG. 3) and/or the contents of the vial 30 can be visually observed. It should be appreciated that the first opening 304 can have any suitable geometry complimentary to receive an associated shaped locking member 20, 104, 204. Accordingly, in one embodiment the first opening 304 can be circular, and can be configured to receive an associated circular locking member 20, 104 (or a locking member 20, 104 defining a circular body). In another embodiment, the first opening 304 can be square or rectangular, and can be configured to receive an associated square or rectangular locking member 204 (or a locking member 204 defining a square or rectangular body). In other examples of embodiments, the first opening 304 has any suitable shape or geometry that is complimentary to the shape or geometry of the locking member 20, 104, 204 that it receives.

The vial sleeve assembly 300 also includes a base 320. The base 320 has a cross-sectional diameter that is greater than a cross-sectional diameter of the vial sleeve 302. Stated another way, the vial sleeve sidewall 302 is concentric to the base 320. Stated yet another way, the base 320 is concentric to the first opening 304 of the vial sleeve 302 (or vial sleeve body 302 or vial sleeve sidewall 302), as the base 320 and the first opening 304 share a common center. The base 320 is coupled to (or defined by) the vial sleeve sidewall 302. In the illustrated embodiment, the base 320 is positioned adjacent (or closer to) the first opening 304 (or vial insertion opening 304) than the second opening 308. In other examples of embodiments, the base 320 can be positioned at any suitable location along the vial sleeve sidewall 302. The base 320 includes a plurality of linear surfaces 324. In the illustrated embodiment, the base 320 include four linear surfaces 324. However, in other examples of embodiments, the base 320 can include any suitable number of linear surfaces 324 (e.g., two, three, five or more, etc.). The linear surfaces 324 are positioned on an outer perimeter (or an outer circumference) of the base 320. In addition, each linear surface 324 is spaced from an adjacent linear surface 324 by a spacer surface 328. In the illustrated embodiment, each spacer surface 328 is arcuate (or curved or non-linear). Stated another way, the base 320 includes alternating linear surfaces 324 and arcuate surfaces 328 positioned around the outer perimeter (or outer circumference) of the base 320. In the illustrated embodiment, the base 320 include four arcuate spacer surfaces 328. However, in other examples of embodiments, the base 320 can include any suitable number of arcuate spacer surfaces 328 (e.g., two, three, five or more, etc.). In addition, the while the spacer surfaces 328 are illustrated as arcuate, in other examples of embodiments, the spacer surfaces 328 can be defined by any suitable shape or geometry to facilitate spacing between adjacent linear surfaces 324. The base 320 can also be referred to as an anti-rotation member 320, as it assists with maintaining a position or orientation of the vial sleeve 302 during installation of an associated locking member 20, 104, 204. It should be appreciated that while the base 320 (or anti-rotation member 320) is illustrated in association with vial sleeve 302, in other examples of embodiments, vial sleeves 50, 102, 202 can include the base 320 (or anti-rotation member 320).

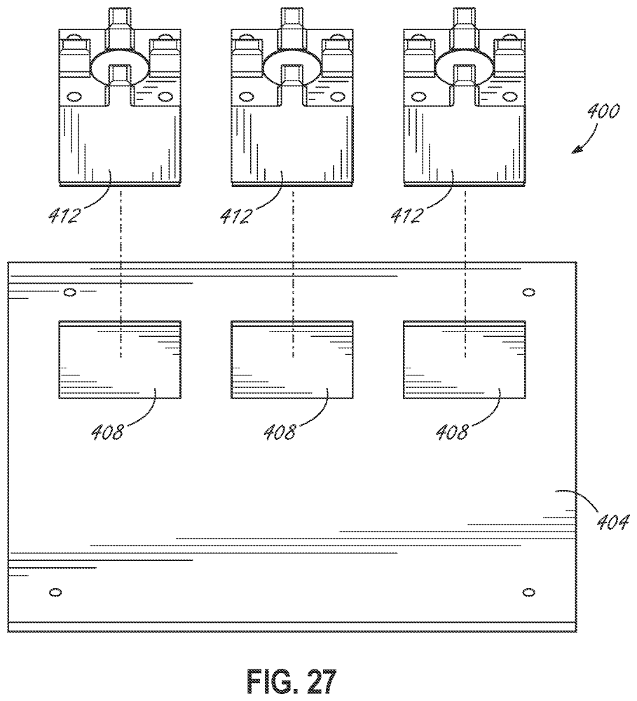

Referring now to FIG. 27, an example of an embodiment of a vial installation assembly 400 is illustrated. The assembly 400 illustrated in FIG. 27 is configured for use with installation of the locking members 20, 104, 204 discussed above, with an associated vial sleeve assembly 10, 100, 300. The assembly 400 includes a base plate 404 is configured to be mounted or fastened to a surface, such as a table, counter, cart, or other structure that supports the base plate 404. The base plate 404 defines at least one fixture mounting recesses 408. In the illustrated embodiment, the base plate 404 defines a plurality of mounting recesses 408, and specifically three mounting recesses 408. In other examples of embodiments, the base plate 404 can define any suitable number of mounting recesses 408 (two, four, five or more, etc.). Each mounting recess 408 is configured to receive a mounting fixture 412. More specifically, a mounting fixture 412 is configured to fasten to the base plate 404 in an associated recess 408. Each fixture 412 can be fastened to the base plate 404 in any suitable manner, including, but not limited to by a fastener (screw, bolt, etc.), adhesive, or any other suitable fastening system configured to couple each fixture 412 to the base plate 404 and withstand cryogenic temperatures. It should be appreciated that the vial installation assembly 400 is configured to be positioned for use in an environment exposed to cryogenic temperatures to facilitate installation of a vial 30 (see FIG. 3) into an associated vial sleeve 302.

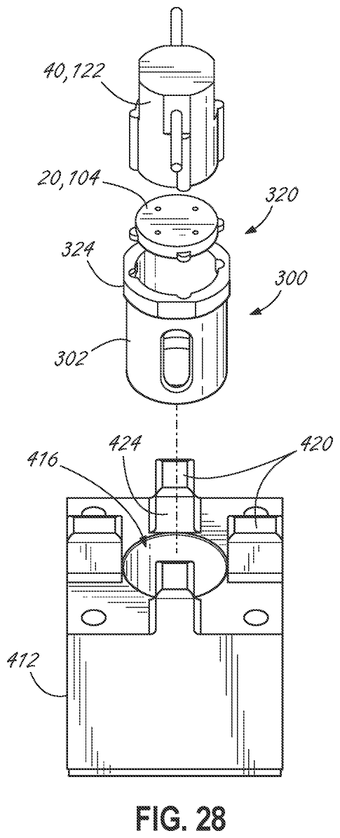

With reference now to FIG. 28, the mounting fixture 412 and associated operation of the vial installation assembly 400 is illustrated in additional detail. Each mounting fixture 412 defines a channel 416 (or aperture 416). The channel 416 is configured to receive the vial sleeve 302. More specifically, the channel 416 is configured to receive the vial sleeve 302 that contains a vial 30 (shown in FIG. 3). The mounting fixture 412 includes a plurality of projections 420 positioned around an outer circumference (or an outer perimeter) of one end of the channel 416. Each projection 420 includes a surface 424 (or face surface 424). The surface 424 is configured to contact an associated linear surface 324 of the base 320 of the vial sleeve 302. By engagement of the surface 424 of each projection 420 with the linear surface 324 of the base 320 of the vial sleeve 302, the mounting fixture 412 restricts rotation of the vial sleeve 302 during attachment (or installation) of the associated locking member 20, 104. It should be appreciated that the mounting fixture 412 is configured for use with attachment of locking member 20, 104 to an associated vial sleeve 302 (or vial sleeve 50, 102).

In operation, a vial 30 (shown in FIG. 3) is inserted into the vial sleeve assembly 300 (shown in FIGS. 25, 26, and 28). More specifically, the vial sleeve 302 is positioned in an inverted position, with the first opening 304 (shown in FIG. 26) positioned facing upward, or exposed. The vial 30 is then inserted into the first opening 304. The cap 32 (or cap end 32) of the vial 30 (see FIG. 3) is inserted first into the first opening 304 until the cap 32 (or cap end 32) is received by the second opening 308 (FIG. 25) to expose the cap 32 out of the vial sleeve 302. The vial sleeve 302, which is carrying the vial 30, is then inserted into the channel 416 of the mounting fixture 412. Once inserted, each linear surface 324 of the base 320 of the vial sleeve 302 is positioned into engagement (or contact) with an associated surface 424 of one of the projections 420. The base 320 and the projections 420 of the mounting fixture 12 are in a keyed arrangement, such that the surfaces 324, 424 contact to restrict rotation of the vial sleeve 302 relative to the mounting fixture 412. The locking member 20, 104 is then positioned in the first end of the vial sleeve 302. A user then engages an associated locking tool 40, 122 with the associated locking member 20, 104. As discussed above, the locking tool 40, 122 is in a keyed relationship with the associated locking member 20, 104. A user can then rotate the locking tool 40, 122 in a first direction, responsively rotating the locking member 20, 104 in the first direction relative to the vial sleeve 302. Since the vial sleeve 302 is restricted from rotation by the mounting fixture 412, the locking member 20, 104 is rotated into locking engagement with the vial sleeve 302. Stated another way, rotation of the locking member 20, 104 relative to the vial sleeve 302 facilitates locking of the locking member 20, 104 to the vial sleeve 302, as discussed above. While FIG. 28 illustrates the vial sleeve 302, it should be appreciated that the mounting fixture 412 can be configured for use with vial sleeves 50, 102.

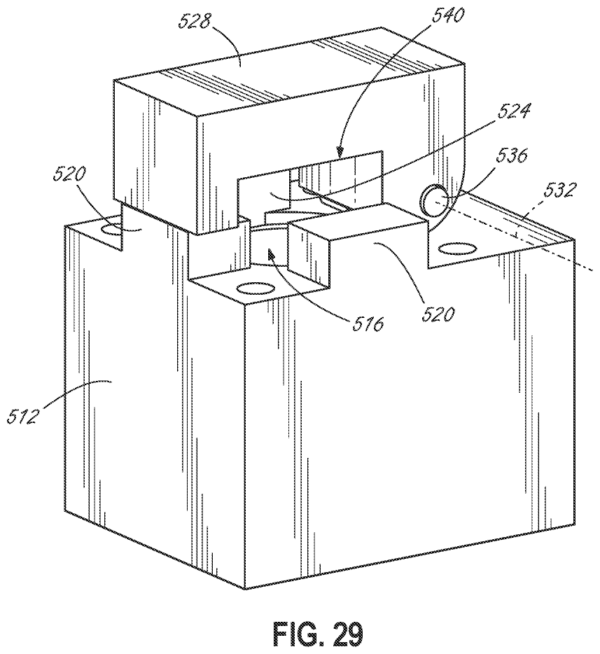

Referring now to FIG. 29, an alternative embodiment of a mounting fixture 512 is illustrated. The mounting fixture 512 is configured to be used in association with the vial installation assembly 400, shown in FIG. 27. The mounting fixture 512 is configured to fasten to the base plate 404 in an associated recess 408. Each fixture 512 can be fastened to the base plate 404 in any suitable manner, including, but not limited to by a fastener (screw, bolt, etc.), adhesive, or any other suitable fastening system configured to couple each fixture 512 to the base plate 404 and withstand cryogenic temperatures. It should be appreciated that the base plate 404 can include fixtures 412, fixtures 512, or a combination of fixtures 412, 512.

With specific reference to FIG. 29, the mounting fixture 512 is configured for operation with a vial sleeve 302 and associated locking member 204, as discussed above. The mounting fixture 512 defines a channel 516 (or aperture 516). The channel 516 is configured to receive the vial sleeve 302. More specifically, the channel 516 is configured to receive the vial sleeve 302 that contains a vial 30 (shown in FIG. 3). The mounting fixture 512 also includes a plurality of projections 520 positioned around an outer circumference (or an outer perimeter) of one end of the channel 516. Each projection 520 includes a surface 524 (or face surface 524). Each surface 524 is adjacent the channel 516 and is configured to contact an associated linear surface 324 of the base 320 of the vial sleeve 302. By engagement of the surface 524 of each projection 520 with the linear surface 324 of the base 320 of the vial sleeve 302, the mounting fixture 412 restricts rotation of the vial sleeve 302 during attachment (or installation) of the associated locking member 204. The fixture 512 also includes an arm 528. The arm 528 is pivotably connected to the mounting fixture 512. More specifically, the arm 528 is configured to pivot relative to the mounting fixture 512 around a pivot axis 532 defined by a pivot member 536. The arm 528 is a generally U-shaped member that defines a recess 540. The recess 540 is configured to receive a portion of the locking member 204 and facilitate insertion/attachment of the locking member 204 to the vial sleeve 302. It should be appreciated that the mounting fixture 512 is configured for use with attachment of locking member 204 to an associated vial sleeve 302 (or 202).

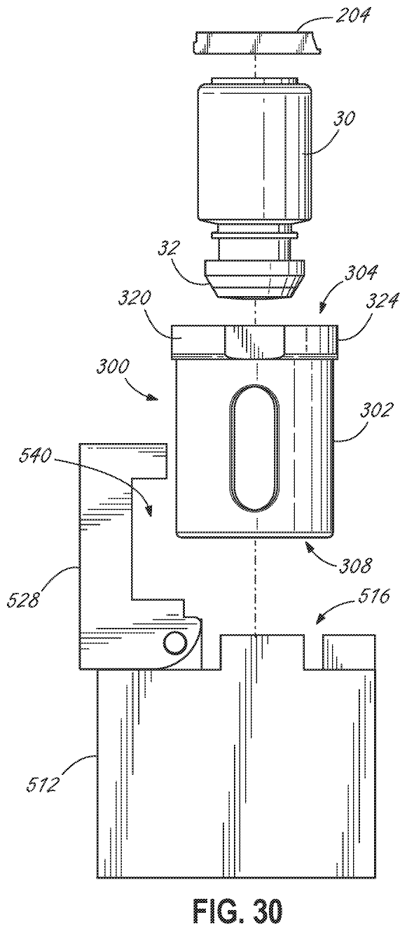

With reference now to FIG. 30, in operation, a vial 30 is inserted into the vial sleeve assembly 300. More specifically, the vial sleeve 302 is positioned in an inverted position, with the first opening 304 positioned facing upward, or exposed. The vial 30 is then inserted into the first opening 304. The cap 32 (or cap end 32) of the vial 30 is inserted first into the first opening 304 until the cap 32 (or cap end 32) is received by the second opening 308 to expose the cap 32 out of the vial sleeve 302. The vial sleeve 302, which is carrying the vial 30, is then inserted into the channel 516 (see also FIG. 29) of the mounting fixture 512. The arm 528 is an open position (or open configuration) to expose the channel 516. Once the vial sleeve 302 is inserted into the channel 516 of the mounting fixture 512, each linear surface 324 of the base 320 of the vial sleeve 302 is positioned into engagement (or contact) with an associated surface 524 of one of the projections 520 (see FIG. 29). The base 320 and the projections 520 of the mounting fixture 512 are in a keyed arrangement, such that the surfaces 324, 524 contact to restrict rotation of the vial sleeve 302 relative to the mounting fixture 512. The locking member 204 is then positioned in the first end of the vial sleeve 302 for attachment to the vial sleeve 302, as discussed further below. In other examples of embodiments, the locking member 204 can be positioned into the recess 540 (or received by the recess 540) and oriented for attachment to the vial sleeve 302, as discussed further below.

To facilitate attachment (or installation or locking) of the locking member 204 to the vial sleeve 302, and as illustrated in FIGS. 22A-22B and 23A-24B, a first end 248 of the locking member 204 is inserted into a first side 222 of the first opening 304. More specifically, a first locking tab 252 is inserted into a locking channel 220 defined by the first side 222 of the first opening 304. The locking member 204 will be in an orientation relative to the first opening 304 of the vial sleeve 302 as shown in FIG. 22B. A user then pivots the arm 528 relative to the mounting fixture 512 to a closed position (or closed configuration) (shown in FIG. 29). As the user rotates the arm 528 relative to the mounting fixture 512 around the pivot axis 532, the recessed portion 540 of the arm 528 contacts the locking member 204. The arm 528 is pushing a second end 250 of the locking member 204 into engagement with a second side 234 of the first opening 304 (see FIG. 22B). Stated another way, the locking member 204 hinges (or pivots) relative to the vial sleeve 302 around the first locking tab 252. As the arm 528 pivots toward the mounting fixture 512, the arm 528 applies a force onto the locking member 204 towards the vial sleeve 302. The force moves (or repositions) the second locking tabs 256 of the locking member 204 (see FIGS. 20 and 24A) towards the vial sleeve 302 into engagement with a second locking channel 236 defined by the second side 234 of the first opening 304. Once the second locking tabs 256 are received by the second locking channel 236, the locking member 204 is locked into engagement with (or fastened to or attached to) the vial sleeve 302. Stated another way, the locking member 204 is in a hinged connection (or pivotable connection) with the vial sleeve 302. During installation, the locking member 204 hinges (or pivots) relative to the first end 248 of the locking member 204. The second end 250 of the locking member 204 is configured to be received by (or inserted into) the second locking channel 236 while the first end 248 of the locking member 204 is received by (or positioned in, or received and retained by, or retained by) the first locking channel 220. More specifically, the second locking tab 256 (or plurality of tabs 256) of the locking member 204 is configured to be inserted into (or received by) the second locking channel 236 while the first locking channel 220 receives and retains the first locking tab 252 (or plurality of tabs 252) of the locking member 204. In response to connection of the second end 250 of the locking member 204 with the vial sleeve 302, the locking member 204 locks (or pivotably locks) to the vial sleeve 302. In addition, in response to locking the locking member 204 to the vial sleeve 302, the locking member 204 restricts withdrawal of the vial 30 through the first opening 304. It should be appreciated that the arm 528 of the mounting fixture 512 is restricted from further movement in the closed configuration by an end of the arm 528 opposite the pivot member 536 contacting an adjacent projection 520. Thus, the projection 520 can act as a pivot stop for the arm 528.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A lockable vial sleeve assembly, comprising:
a sleeve configured to house a vial, the sleeve defining:
a body;
a first opening provided at one end of the body, the first opening configured to receive the vial therethrough;
a second opening provided at another end of the body, the second opening positioned opposite the first opening; and
a locking member configured to pivotably lock to the sleeve adjacent the one end,
wherein the vial is insertable into the body through the first opening, and
wherein in response to the locking member being pivotably locked to the sleeve, the locking member at least partially closes the first opening to restrict withdrawal of the vial through the first opening.

2. The lockable vial sleeve assembly of claim 1, wherein the second opening has a cross-sectional diameter that is less than a cross-sectional diameter of the first opening.

3. The lockable vial sleeve assembly of claim 2, wherein the second opening is configured to receive a portion of the vial.

4. The lockable vial sleeve assembly of claim 3, wherein the second opening is configured to receive a cap of the vial.

5. The lockable vial sleeve assembly of claim 1, wherein the sleeve further defining a base, the base is defined by the body.

6. The lockable vial sleeve assembly of claim 5, wherein the base is concentric to the first opening.

7. The lockable vial sleeve assembly of claim 6, wherein the base defines a plurality of linear surfaces positioned on an outer perimeter of the base.

8. The lockable vial sleeve assembly of claim 7, wherein the base defines a plurality of non-linear spacer surfaces, each linear surface is spaced from an adjacent linear surface by one of the plurality of spacer surfaces.

9. The lockable vial sleeve assembly of claim 1, wherein the sleeve defines a square first opening, and the locking member defines a complimentary square body, the locking member configured to be received by the first opening.

10. The lockable vial sleeve assembly of claim 1, wherein the sleeve defines a rectangular first opening, and the locking member defines a complimentary rectangular body, the locking member configured to be received by the first opening.

11. The lockable vial sleeve assembly of claim 1, wherein the sleeve defines a first locking channel and a second locking channel, the locking member includes a first locking tab and a second locking tab, the first locking tab is configured to engage the first locking channel, and the second locking tab is configured to engage the second locking channel.

12. The lockable vial sleeve assembly of claim 11, wherein the first locking tab is positioned on a first side of the locking member, and the second locking tab is positioned on a second side of the locking member.

13. The lockable vial sleeve assembly of claim 12, wherein the first side of the locking member is opposite the second side of the locking member.

14. The lockable vial sleeve assembly of claim 1, wherein the locking member includes a first locking tab and a second locking tab, the second locking tab is configured to engage the sleeve while the first locking tab is in engagement with the sleeve.

15. The lockable vial sleeve assembly of claim 1, wherein the sleeve defines a first locking channel spaced from a second locking channel, and the locking member includes a first locking tab and a second locking tab, the second locking tab is configured to be inserted into the second locking channel while the first locking channel receives and retains the first locking tab.

16. The lockable vial sleeve assembly of claim 15, wherein the first locking channel is positioned on an opposite side of the sleeve as the second locking channel.

17. A lockable vial sleeve assembly, comprising:
a sleeve configured to house a vial, the sleeve including:
a body; and
a first opening provided at one end of the body, the first opening configured to receive the vial therethrough; and
a locking member configured to rotatably lock to the body adjacent the one end,
wherein in response to the locking member being rotatably locked to the body, the locking member at least partially closes the first opening to restrict withdrawal of the vial through the first opening.

18. The lockable vial sleeve assembly of claim 17,
wherein the body includes at least one first locking feature provided adjacent the one end; and
the locking member defines at least one second locking feature configured to cooperate with the at least one first locking feature to rotatably lock the locking member with the body adjacent the one end.

19. The lockable vial sleeve assembly of claim 17, further comprising:
a locking tool configured to releasably engage with the locking member and being operable to rotate the locking member relative to the body to rotatably lock the locking member with the body adjacent the one end.

20. The lockable vial sleeve assembly of claim 17,
wherein the at least one first locking feature includes at least one locking recess formed in an inner surface of the body adjacent the one end; and
the at least one second locking feature includes at least one locking lug configured to cooperate with the at least one locking recess to rotatably lock the locking member with the body adjacent the one end.
